(19) United States
(12) Patent Application Publication
(10) Pub. No.: US 2021/0064549 A1
(43) Pub. Date: Mar. 4, 2021

(54) ENHANCING THE SPEED PERFORMANCE AND ENDURANCE OF SOLID-STATE DATA STORAGE DEVICES WITH EMBEDDED IN-LINE ENCRYPTION ENGINES

(71) Applicant: ScaleFlux, Inc., San Jose, CA (US)

(72) Inventors: Tong Zhang, Albany, NY (US); Yang Liu, Milpitas, CA (US); Fei Sun, Irvine, CA (US); Hao Zhong, Los Gatos, CA (US)

(21) Appl. No.: 16/558,694

(22) Filed: Sep. 3, 2019

(51) Int. Cl. G06F 12/14; G06F 21/60; G06F 21/79; H04L 9/14; H04L 9/06

(52) U.S. Cl. CPC G06F 12/1408; G06F 21/602; G06F 2212/1052; H04L 9/14; H04L 9/0643; G06F 21/79

(57) ABSTRACT

A solid-state data storage device according to embodiments includes, a storage device controller; solid-state memory; and an inline encryption engine, embedded in the storage device controller, for encrypting data blocks received from a host using a set of encryption keys and writing the encrypted data blocks into the solid-state memory, wherein data blocks having similar lifetimes are encrypted using the same encryption key.

### TECHNICAL FIELD

The present invention relates to the field of solid-state data storage, and particularly to improving the speed performance and endurance of solid-state data storage devices using NAND flash memory.

### BACKGROUND

Modern solid-state data storage devices, e.g., solid-state drives (SSDs), are built upon NAND flash memory chips. NAND flash memory cells are organized in an array 4 block 4 page hierarchy, where one NAND flash memory array is partitioned into a large number (e.g., thousands) of blocks, and each block contains a number (e.g., hundreds) of pages. Data are programmed and fetched in the unit of a page. The size of each flash memory page typically ranges from 8 kB to 32 kB, and the size of each flash memory block is typically tens of MBs.

Each time when writing data to NAND flash memory cells, the memory cells must be erased, with the erase operation carried out in the unit of a block. All of the memory cells within the same block must be erased at the same time.

A solid-state data storage device exposes its storage space in an array of logical block addresses (LBAs). A host (e.g., computing device, server, etc.) can access the solid-state data storage device (i.e., read and write data) through the LBAs. Because NAND flash memory does not support in-place data update, subsequent data being written to the same LBA will be internally written to a different physical storage location inside the solid-state data storage device. As a result, physical storage space inside the solid-state data storage device will gradually become more and more fragmented, requiring the solid-state data storage device to periodically carry out an internal garbage collection (GC) operation to reclaim stale physical storage space and reduce fragmentation. However, the GC operation causes extra data write operations, which is referred to as write amplification. Larger write amplification will degrade the speed performance (i.e., throughput and latency) and endurance of the solid-state data storage device.

It is well known that writing data with a similar lifetime (i.e., how long the data will remain as valid) into the same NAND flash memory erase unit can significantly reduce write amplification, leading to better storage device speed performance and endurance. Therefore, it is highly desirable to classify data in terms of lifetime. With the best knowledge about their own data, applications can directly provide data lifetime information to the underlying data storage sub-system. However, the application source code needs to be modified to explicitly extract and provide the data lifetime information, which unfortunately largely limits the practical applicability of this approach. Hence, it is highly desirable for storage devices on their own to classify data in terms of different lifetimes without any changes to the applications.

### SUMMARY

Accordingly, embodiments of the present disclosure are directed to improving the speed performance and endurance of solid-state data storage devices using NAND flash memory.

A first aspect of the disclosure is directed to a solid-state data storage device, including: a storage device controller; solid-state memory; and an inline encryption engine, embedded in the storage device controller, for encrypting data blocks received from a host using a set of encryption keys and writing the encrypted data blocks into the solid-state memory, wherein data blocks having similar lifetimes are encrypted using the same encryption key.

A second aspect of the disclosure is directed to a method for storing encrypted data blocks in a solid-state data storage device including an embedded inline encryption engine, including: encrypting, using the inline encryption engine, data blocks received from a host using a set of encryption keys, wherein data blocks having similar lifetimes are encrypted using the same encryption key; and writing the encrypted data blocks into a solid-state memory of the solid-state data storage device.

### BRIEF DESCRIPTION OF THE DRAWINGS

The numerous advantages of the present disclosure may be better understood by those skilled in the art by reference to the accompanying figures.

FIG. 1 illustrates a solid-state data storage device with an embedded inline encryption engine according to embodiments.

FIG. 2 illustrates an enhanced LBA-PBA mapping table according to embodiments.

FIG. 3 illustrates the use of multiple write-active NAND flash memory erase units according to embodiments.

FIG. 4 illustrates an operational flow diagram of a method for processing each data block being written by a host to the solid-state data storage device of FIG. 1 according to embodiments.

FIG. 5 illustrates an operational flow diagram of an internal garbage collection (GC) operation carried out by the solid-state data storage device of FIG. 1 according to embodiments.

### DETAILED DESCRIPTION

Reference will now be made in detail to embodiments of the disclosure, examples of which are illustrated in the accompanying drawings.

Due to the increasing importance of security, more and more systems demand that data are encrypted when being stored in storage devices. However, being computation-intensive, data encryption/decryption often consumes a significant amount of CPU cycles. One solution is to off-load data encryption/decryption to a dedicated hardware encryption engine. Among different options of data encryption/decryption off-loading, inline encryption may achieve the best efficiency.

A dedicated hardware encryption engine may be located on the data write path between the host CPU and a solid-state data storage device. When the host CPU writes a data block to the solid-state data storage device, the data block passes through the inline encryption engine that on-the-fly encrypts the data and directly sends the encrypted data block to the solid-state data storage device. When the host CPU reads a data block from the solid-state data storage device, the encrypted data block passes through the inline encryption engine that on-the-fly decrypts the data and directly sends the decrypted original data block back to the host CPU. The inline encryption engine may be physically located either in the host computer or in the solid-state data storage device. The present disclosure focuses on the scenario where an inline encryption engine is embedded within a NAND solid-state data storage device.

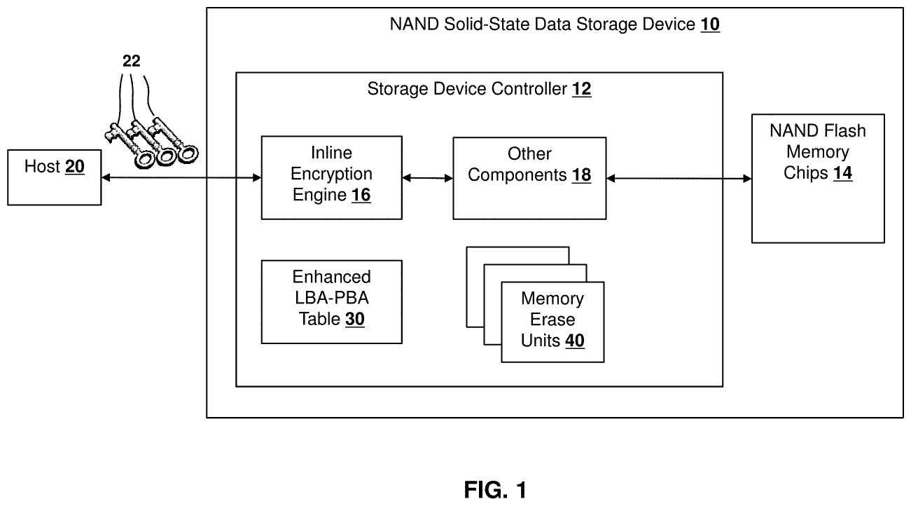

As depicted in FIG. 1, a NAND solid-state data storage device 10 (hereafter storage device 10) includes a storage device controller 12 and a set of NAND flash memory chips 14. According to embodiments, the storage device controller 12 further includes an inline encryption engine 16. The storage device 10 may include other components 18 as is known in the art.

To carry out data encryption, a host 20 (e.g., computing device, server, etc.) provides a corresponding encryption key 22 to the inline encryption engine 16. The size of each encryption key 22 is typically 128-bit or 256-bit. Different users/applications may use different encryption keys 22. For example, data (Data₁) generated by a first user (User₁) working with a first application (App₁) may use or be associated with a first encryption key 22 (Key₁), while the data (Data₂) generated by a second user (User₂) working with the first application (App₁) may use or be associated with a second, different encryption key 22 (Key₂). To this extent, the inline encryption engine 16 will encrypt the data (Data₁) from the user/application combination (User₁/App₁) using the first encryption key 22 (Key₁) and encrypt the data (Data₂) from the user/application combination (User₂/App₁) using the second encryption key 22 (Key₂).

The host 20 may pre-load a set of different encryption keys 22 into the inline encryption engine 16 and assign a unique ID to each encryption key 22. The ID of an encryption key 22 may correspond, for example, to a different user/application combination. In such a case, during runtime, the host 20 may provide the inline encryption engine 16 with the ID(s) of the encryption key(s) 22 that should be used for the data being written/read to/from the storage device 10. The host 20 may dynamically change the set of encryption keys 22 that are stored in the inline encryption engine 16.

According to embodiments, data is classified in terms of lifetime based on its corresponding encryption key 22. Different users/applications may use different encryption keys 22, and meanwhile data written by the same user/application may more likely have a similar lifetime. This is particular true for users/applications that heavily use immutable data. As described above, the speed and endurance performance of solid-state data storage devices can be significantly improved by writing data with similar lifetimes into the same NAND flash memory erase unit. Advantageously, using the inline encryption engine 16 embedded in the storage device 10, the storage device controller 12 can readily distinguish the data of different users/applications based on the use of different encryption keys 22. Continuing the above example, the encryption key 22 (Key₁) may be used by the storage device controller 12 to distinguish the data (Data₁) generated by the user/application combination (User₁/App₁) from other data (e.g., data (Data₂) generated by the user/application combination (User₂/App₁)). By assuming that data from the same user/application combination tends to more likely have a similar lifetime, the present disclosure aims to store data encrypted with the same encryption key 22 (e.g., data from the same user/application) into the same NAND flash memory erase unit.

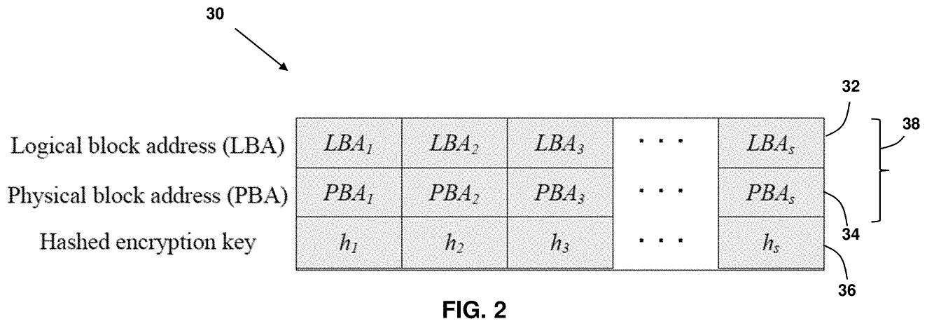

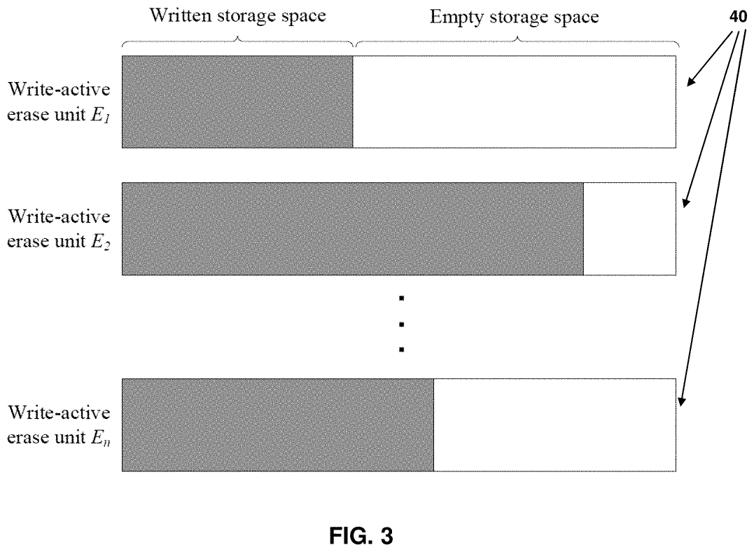

According to embodiments, to implement this process, the storage device controller 12 of the storage device 10 includes: a) an enhanced LBA-PBA mapping table; and b) multiple write-active erase units. An example of an enhanced LBA-PBA table is depicted in FIG. 2. Multiple write-active erase units are depicted in FIG. 3.

Enhanced LBA-PBA Mapping Table

A solid-state data storage device exposes its storage space in an array of logical block addresses (LBAs), where the host always uses the LBAs to access the solid-state data storage device. Internally, the solid-state data storage device assigns one unique physical block address (PBA) to each NAND flash memory page that physically stores one data block. The controller of the solid-state data storage device maintains an LBA-PBA mapping table that records the mapping between each LBA and its associated PBA.

According to embodiments, as illustrated in FIG. 2, the storage device controller 12 of the storage device 10 maintains an enhanced LBA-PBA mapping table 30 that includes the mapping between each LBA 32 and its associated PBA 34 together with a hashed encryption key 36 (denoted as hᵢ) for each LBA-PBA entry 38 in the enhanced mapping table 30. Let kᵢ denote the encryption key 22 being used to encrypt the data at LBA Lᵢ. A fixed hashing function ƒₕ is used to hash the encryption key kᵢ to obtain hᵢ, where the size of hᵢ is very small (e.g., a few bits) and is much less than the size of each encryption key 22 (e.g., 128 bits or 256 bits). By introducing the element of a hashed encryption key hᵢ in each LBA-PBA entry 38 in the enhanced mapping table 30, the storage device controller 12 can readily distinguish data that have been encrypted with different encryption keys 22. Any suitable fixed hashing function ƒₕ may be used to hash the encryption key kᵢ to obtain hᵢ.

Multiple Write-Active Erase Units

In conventional practice, the controller of a solid-state data storage device typically keeps only one NAND flash memory erase unit as write-active, i.e., keeps one erase unit open to absorb write activities. After one write-active erase unit is completely filled, it is sealed (i.e., transitioned to be write-inactive). The controller of the solid-state data storage device then allocates another empty erase unit to be write-active in order to absorb subsequent write activities.

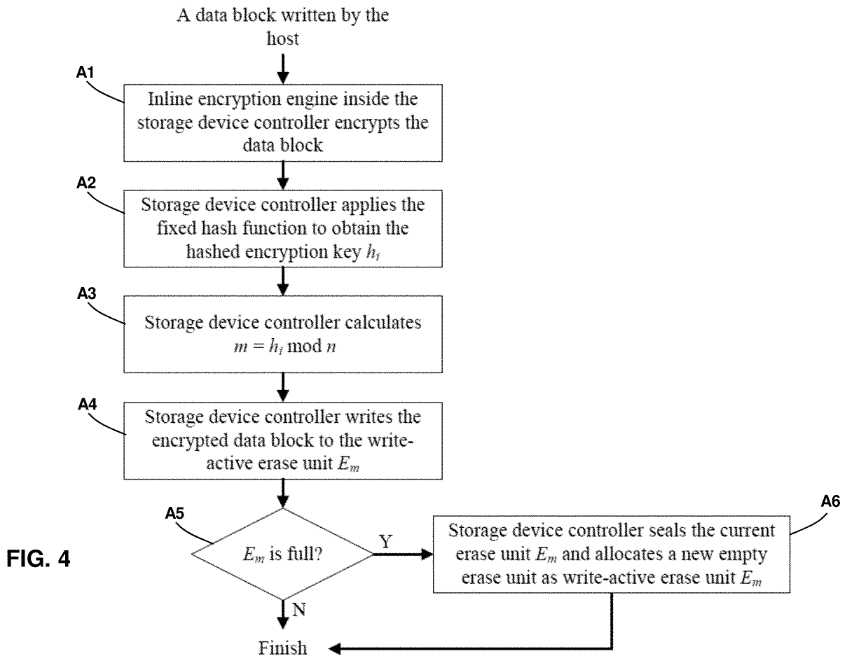

According to embodiments, to ensure data of different users/applications are stored in different NAND flash memory erase units, the storage device controller 12 maintains multiple NAND flash memory erase units 40 as write-active, as illustrated in FIG. 3. An operational flow diagram of a method for processing each data block being written by the host 20 to the storage device 10 is depicted in FIG. 4. FIGS. 3 and 4 are referred to concurrently.

Let n denote the number of write-active erase units E₁, E₂, . . . Eₙ that are available to absorb writes from the host 20 at a given same time. For each data block being encrypted and written to the NAND flash memory 14, the inline encryption engine 16, which is embedded in the storage device controller 12 of the storage device 10, obtains the corresponding encryption key kᵢ. At process A1, the inline encryption engine 16 encrypts the data block using the encryption key kᵢ. Meanwhile, at process A2, the storage device controller 12 of the storage device 10 applies a fixed hashing function ƒₕ onto the encryption key kᵢ to obtain a corresponding hashed encryption key hᵢ.

At process A3, the storage device controller 12 calculates m=hᵢ mod n. At process A4, the storage device controller 12 writes the encrypted data block into the write-active erase unit Eₘ. As such, data blocks with a similar lifetime (e.g., as indicated by having the same hashed encryption key hᵢ) are written into the same write-active erase unit Eₘ. If the write-active erase unit Eₘ becomes full (Y at process A5), the storage device controller 12 seals the write-active erase unit Eₘ at process A6 (i.e., transitions the write-active erase unit Eₘ to write-inactive) and allocates a new empty erase unit as a new write-active erase unit Eₘ.

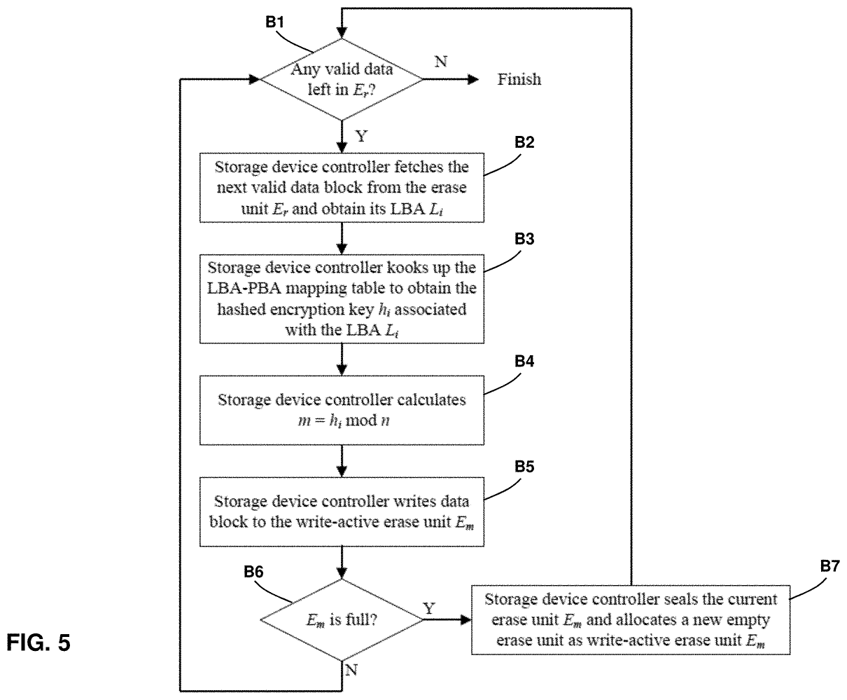

In addition to serving write requests from the host 20, the storage device controller 12 also periodically carries out garbage collection (GC). The objective of GC is to reclaim the stale storage space in an erase unit. FIG. 5 illustrates an operational flow diagram of an internal GC operation carried out by the storage device controller 12 of the storage device 10 according to embodiments.

Let Eᵣ denote the erase unit to be reclaimed. The task of the GC operation is to copy all the valid data from the erase unit Eᵣ to other write-active erase units. As illustrated in FIG. 5, at process B1, the storage device controller 12 determines if there is any valid data left in the erase unit Eᵣ. If so (Y at process B1), at process B2, the storage device controller 12 fetches the next valid data block from the erase unit Eᵣ and obtains its LBA Lᵢ (e.g., from the enhanced LBA-PBA table 30 (FIG. 2)). At process B3, the storage device controller 12 obtains the hashed encryption key hᵢ associated with the LBA Lᵢ from the enhanced LBA-PBA table 30. At process B4, the storage device controller 12 calculates m=hᵢ mod n. Recall that n denote the number of write-active erase units E₁, E₂, Eₙ that are available to absorb writes from the host 20 at the same time. At process B5, the storage device controller 12 copies the data block from the erase unit Eᵣ to the write-active erase unit Eₘ. If the write-active erase unit Eₘ becomes full (Y at process B6), at process B7, the storage device controller 12 seals the write-active erase unit Eₘ (i.e., transitions the write-active erase unit Eₘ to write-inactive) and allocates a new empty erase unit as a new write-active erase unit Eₘ. If the write-active erase unit Eₘ is not full (N at process B6), flow passes back to process B1.

It is understood that aspects of the present disclosure may be implemented in any manner, e.g., as a software program, or an integrated circuit board or a controller card that includes a processing core, I/O and processing logic. Aspects may be implemented in hardware or software, or a combination thereof. For example, aspects of the processing logic may be implemented using field programmable gate arrays (FPGAs), ASIC devices, or other hardware-oriented system.

Aspects may be implemented with a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, etc. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by hardware and/or computer readable program instructions.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing description of various aspects of the present disclosure has been presented for purposes of illustration and description. It is not intended to be exhaustive or to limit the concepts disclosed herein to the precise form disclosed, and obviously, many modifications and variations are possible. Such modifications and variations that may be apparent to an individual in the art are included within the scope of the present disclosure as defined by the accompanying claims.

1. A solid-state data storage device, comprising:
a storage device controller;
solid-state memory; and
an inline encryption engine, embedded in the storage device controller, for encrypting data blocks received from a host using a set of encryption keys and writing the encrypted data blocks into the solid-state memory, wherein data blocks having similar lifetimes are encrypted using the same encryption key.

2. The solid-state data storage device according to claim 1, wherein each encryption key is associated with a different user/application combination on the host.

3. The solid-state data storage device according to claim 1, wherein the host provides the data blocks and the set of encryption keys to the inline encryption engine.

4. The solid-state data storage device according to claim 1, wherein the set of encryption keys are pre-loaded into the inline encryption engine, and wherein the host provides the data blocks and IDs of the encryption keys to be used to encrypt the data blocks to the inline encryption engine.

5. The solid-state data storage device according to claim 1, wherein the storage device controller includes n (n>1) write-active erase units E₁, E₂, . . . Eₙ.

6. The solid-state data storage device according to claim 5, wherein, for each data block, the inline encryption engine is configured to encrypt the data block using a corresponding encryption key from the set of encryption keys, and wherein the storage device controller is configured to apply a hash function to the corresponding encryption key to obtain a corresponding hashed encryption key hᵢ.

7. The solid-state storage device according to claim 6, wherein the storage device controller is configured to write the encrypted data block into an write-active erase unit Eₘ, wherein m=hᵢ mod n.

8. The solid-state storage device according to claim 7, wherein, if the write-active erase unit Eₘ becomes full, the storage device controller is configured to seal the full write-active erase unit Eₘ and allocate an empty erase unit as a new write-active erase unit Eₘ.

9. The solid-state storage device according to claim 5, wherein the storage device controller further includes an enhanced logical block address (LBA) to physical block address (PBA) mapping table, the enhanced LBA-PBA mapping table including, for each data block, a mapping of the LBA of the data block to its associated PBA in the solid-state memory together with a hashed encryption key hᵢ.

10. The solid-state storage device according to claim 9, wherein the storage device controller is further configured to perform a garbage collection operation on an erase unit Eᵣ by:
for each data block in the erase unit Eᵣ:
using the LBA of the data block to obtain the hashed encryption key hᵢ for the data block from the enhanced LBA-PBA mapping table;
calculating m=hᵢ mod n to determine the write-active erase unit Eₘ where the data block is to be written; and
writing the data block into the write-active erase unit Eₘ.

11. The solid-state storage device according to claim 10, wherein, if the write-active erase unit Eₘ becomes full, the storage device controller is configured to seal the full write-active erase unit Eₘ and allocate an empty erase unit as a new write-active erase unit Eₘ.

12. A method for storing encrypted data blocks in a solid-state data storage device including an embedded inline encryption engine, comprising:
encrypting, using the inline encryption engine, data blocks received from a host using a set of encryption keys, wherein data blocks having similar lifetimes are encrypted using the same encryption key; and
writing the encrypted data blocks into a solid-state memory of the solid-state data storage device.

13. The method according to claim 12, wherein each encryption key is associated with a different user/application combination on the host.

14. The method according to claim 12, further comprising providing the data blocks and the set of encryption keys from the host to the inline encryption engine.

15. The method according to claim 12, further comprising:
pre-loading the set of encryption keys into the inline encryption engine; and
providing the data blocks and IDs of the encryption keys to be used to encrypt the data blocks from the host to the inline encryption engine.

16. The method according to claim 12, wherein the storage device controller includes n (n>1) write-active erase units E₁, E₂, . . . Eₙ, and wherein the method further comprises, for each data block:
encrypting the data block using a corresponding encryption key from the set of encryption keys;
applying a hash function to the corresponding encryption key to obtain a corresponding hashed encryption key hᵢ, and
writing the encrypted data block into an write-active erase unit Eₘ, wherein m=hᵢ mod n.

17. The method according to claim 16, wherein, if the write-active erase unit Eₘ becomes full, the method further comprises:
sealing the full write-active erase unit Eₘ; and
allocating an empty erase unit as a new write-active erase unit Eₘ.

18. The method according to claim 16, further comprising:
providing an enhanced logical block address (LBA) to physical block address (PBA) mapping table, the enhanced LBA-PBA mapping table including, for each data block, a mapping of the LBA of the data block to its associated PBA in the solid-state memory together with the hashed encryption key hᵢ.

19. The method according to claim 18, further comprising performing a garbage collection operation on an erase unit Eᵣ by:
for each data block in the erase unit Eᵣ:
using the LBA of the data block to obtain the hashed encryption key hᵢ for the data block from the enhanced LBA-PBA mapping table;
calculating m=hᵢ mod n to determine the write-active erase unit Eₘ where the data block is to be written; and
writing the data block into the write-active erase unit Eₘ.
